(19) United States
(12) Patent Application Publication
(10) Pub. No.: US 2025/0256577 A1
(43) Pub. Date: Aug. 14, 2025

(54) INFORMATION PROCESSING DEVICE

(71) Applicant: TOYOTA JIDOSHA KABUSHIKI KAISHA, Toyota-shi (JP)

(72) Inventors: Yasuaki NADAYA, Toyota-shi (JP); Kouichi MASAMURA, Toyota-shi (JP); Masashi KOMEYA, Toyota-shi (JP); Sae ONISHI, Toyota-shi (JP); Makiho KAWAKAMI, Toyota-shi (JP); Akihiro YATSUZUKA, Yaizu-shi (JP)

(73) Assignee: TOYOTA JIDOSHA KABUSHIKI KAISHA, Toyota-shi (JP)

(21) Appl. No.: 18/981,804

(22) Filed: Dec. 16, 2024

(30) Foreign Application Priority Data
Feb. 9, 2024 (JP) 2024-018890

(51) Int. Cl. B60K 35/81; B60K 35/28

(52) U.S. Cl. CPC B60K 35/81; B60K 35/28; B60K 2360/162; B60K 2360/188; B60K 2360/349

(57) ABSTRACT

An information processing device, that includes a processor, the processor being configured to increase a brightness of an intra-vehicle monitor provided in front of a driver seat, and display, overlaid on the monitor, a specifying layer in which, among vehicle information related to a vehicle displayed at the monitor, an opacity of a first region, which is a specifying region at which is displayed first information that is specified information, is made lower than an opacity of a second region at which is displayed second information that is the vehicle information other than the specified information.

### CROSS-REFERENCE TO RELATED APPLICATION

This application is based on and claims priority under 35 USC 119 from Japanese Patent Application No. 2024-018890 filed on Feb. 9, 2024, the disclosure of which is incorporated by reference herein.

### BACKGROUND

### Technical Field

The present disclosure relates to an information processing device.

### Related Art

Japanese Patent Application Laid-open (JP-A) No. 2013-57568 discloses a meter display device capable of improving the visibility of information obtained from a position of a pointer.

### SUMMARY

An aspect of the present disclosure is an information processing device, including a processor. The processor is configured to increase a brightness of an intra-vehicle monitor provided in front of a driver seat, and display, overlaid on the monitor, a specifying layer in which, among vehicle information related to a vehicle displayed at the monitor, an opacity of a first region, which is a specifying region at which is displayed first information that is specified information, is made lower than an opacity of a second region at which is displayed second information that is the vehicle information other than the specified information.

### BRIEF DESCRIPTION OF THE DRAWINGS

FIG. 1 is a block diagram illustrating a hardware configuration of a vehicle.

FIG. 2 is a flowchart illustrating a flow of specifying processing.

FIG. 3A is an explanatory diagram illustrating a specifying layer.

FIG. 3B is an explanatory diagram illustrating a specifying layer.

FIG. 3C is an explanatory diagram illustrating a specifying layer.

FIG. 4 is a first explanatory view illustrating changes in illumination color of gauges.

FIG. 5 is a second explanatory view illustrating changes in illumination color of gauges.

FIG. 6 is a third explanatory view illustrating changes in illumination color of gauges.

### DESCRIPTION OF THE INVENTION

Explanation follows regarding a vehicle 10 according to the present exemplary embodiment.

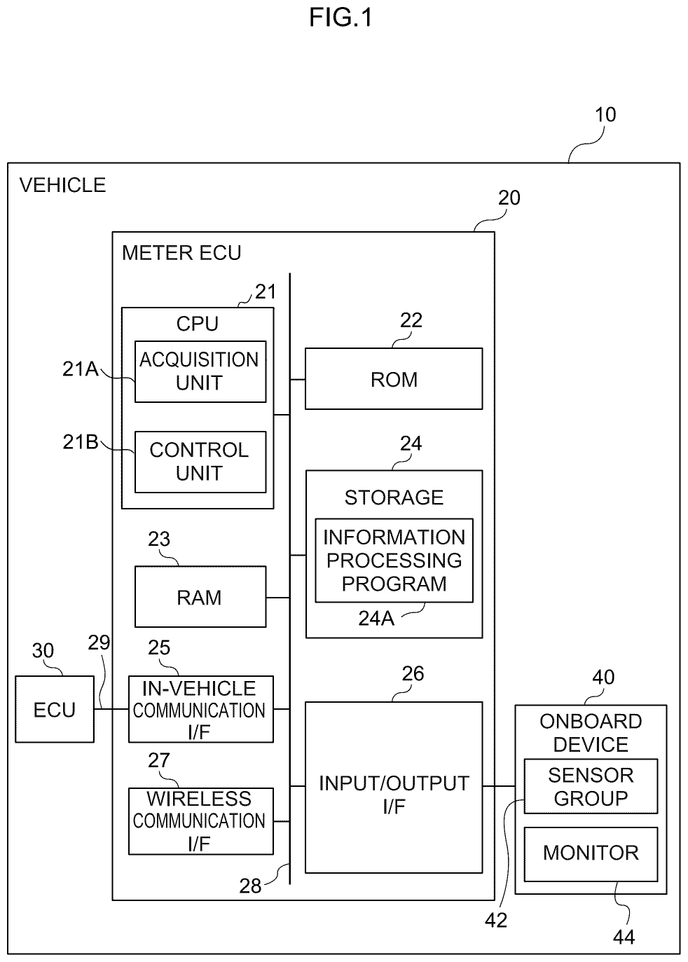

FIG. 1 is a block diagram illustrating a hardware configuration of a vehicle 10. As illustrated in FIG. 1, the vehicle 10 is provided with a meter ECU 20. The meter ECU 20 is an example of an information processing device.

The meter ECU 20 is configured including a CPU (Central Processing Unit) 21 that is a hardware processor, a ROM (Read Only Memory) 22, a RAM (Random Access Memory) 23, a storage 24, an in-vehicle communication interface (I/F) 25, an input/output I/F 26, and a wireless communication I/F 27. The CPU 21, the ROM 22, the RAM 23, the storage 24, the in-vehicle communication I/F 25, the input/output I/F 26, and the wireless communication I/F 27 are connected so as to be capable of communicating with each other via an internal bus 28.

The CPU 21 executes various programs, and controls each unit. Namely, the CPU 21 loads a program from the ROM 22 or the storage 24, and executes the program using the RAM 23 as a work space. The CPU 21 controls each of the above configurations and performs various arithmetic processing in accordance with programs stored in the ROM 22 or the storage 24.

The ROM 22 stores various programs and various data. The RAM 23 temporarily stores programs or data as a work space.

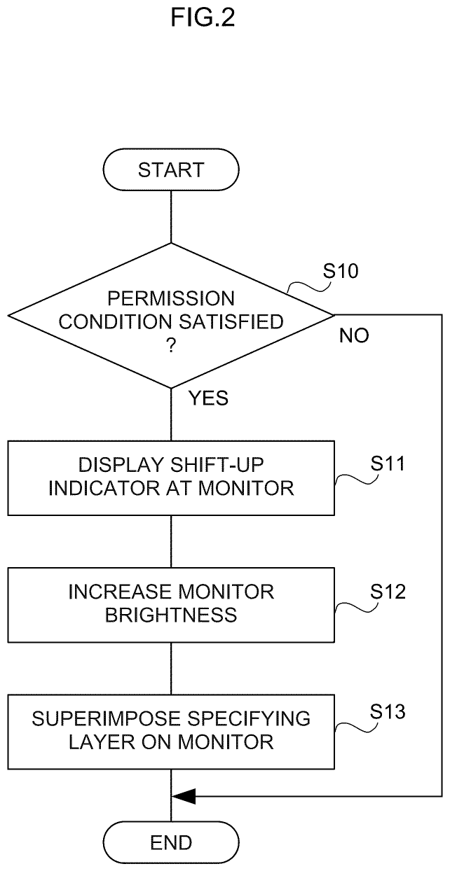

The storage 24 is configured by a storage device that is a non-transitory recording medium such as an embedded multiple media card (eMMC) or a universal flash storage (UFS), and various programs and various data are stored. An information processing program 24A is stored in the storage 24. The information processing program 24 A is a program for causing the CPU 21 to execute specifying processing (see FIG. 2), described later.

The in-vehicle communication I/F 25 is an interface for connecting to another ECU 30. A communication standard according to the CAN protocol is used as the interface. The in-vehicle communication I/F 25 is connected to the external bus 29. Note that plural ECUs are provided for respective functions of the vehicle 10 in addition to the ECU 30.

The input/output I/F 26 is an interface for communicating with an onboard device 40 installed in the vehicle 10.

The onboard device 40 includes various devices installed in the vehicle 10. The vehicle 10 includes a sensor group 42 and a monitor 44, as examples of onboard devices 40.

The sensor group 42 includes, for example, sensors for detecting a state of the vehicle 10 and circumstances in the vicinity of the vehicle 10, such as 3D-LiDAR, a millimeter wave sensor, an infrared sensor, a winker sensor, an accelerator position sensor, a vehicle speed sensor, a steering angle sensor, an angular velocity sensor, a GPS (Global Positioning System) sensor, an illumination sensor, a gyro sensor, and an acceleration sensor. The sensor group 42 outputs detection results of each sensor to the meter ECU 20, the ECU 30, and the like.

The monitor 44 is provided at a meter panel disposed in front of the driver seat of the vehicle 10, and is a liquid crystal monitor for displaying suggestions for operation related to functions of a vehicle 10, and images and the like related to explanation of these functions. The monitor 44 is an example of “a display unit”.

The wireless communication I/F 27 is a wireless communication module for communicating with external devices. As the wireless communication module, communication standards such as 5G, LTE, Wi-Fi (registered trademark), and Bluetooth (registered trademark) are used, for example.

The CPU 21 of the meter ECU 20 has, as functional configuration, an acquisition unit 21A and a control unit 21B. Each functional configuration is realized when the CPU 21 reads out and executes the information processing program 24A stored in the storage 24.

The acquisition unit 21A acquires various types of information. For example, the acquisition unit 21A acquires data input from the ECU 30 via the in-vehicle communication I/F 25, data input from the sensor group 42 via the input/output I/F 26, and the like, as various types of information.

The control unit 21B performs display control related to display at the monitor 44. For example, as the display control, the control unit 21 B appropriately changes the display content of the monitor 44, or adjusts the luminance of the monitor 44.

FIG. 2 is a flowchart illustrating a flow of specifying processing executed by the meter ECU 20. Specifying processing is performed by the CPU 21 reading the information processing program 24A from the storage 24, deploying the information processing program 24A in the RAM 23, and executing the program. As an example, the specifying processing is automatically performed repeatedly each time a predetermined period of time elapses.

In step S10 illustrated in FIG. 2, the CPU 21 determines whether or not permission conditions for changing the travel performance of the vehicle 10 have been satisfied. Here, when the CPU 21 determines that the permission conditions have been satisfied (step S10: YES), the processing proceeds to step S11. When the CPU 21 determines that the permission conditions have not been satisfied (step S10: NO), the CPU 21 ends the specifying processing. In the present exemplary embodiment, the permission condition is a condition for increasing the vehicle speed at which the speed limiter of the vehicle 10 is actuated, as an example of changing the travel performance of the vehicle 10. As an example, in cases in which the current position of the vehicle 10 measured by the GPS sensor included in the sensor group 42 belongs to a predetermined travel area, the CPU 21 determines that the permission condition has been satisfied. The predetermined travel area is, for example, a circuit field in which motor sports are performed, a rally course, or the like.

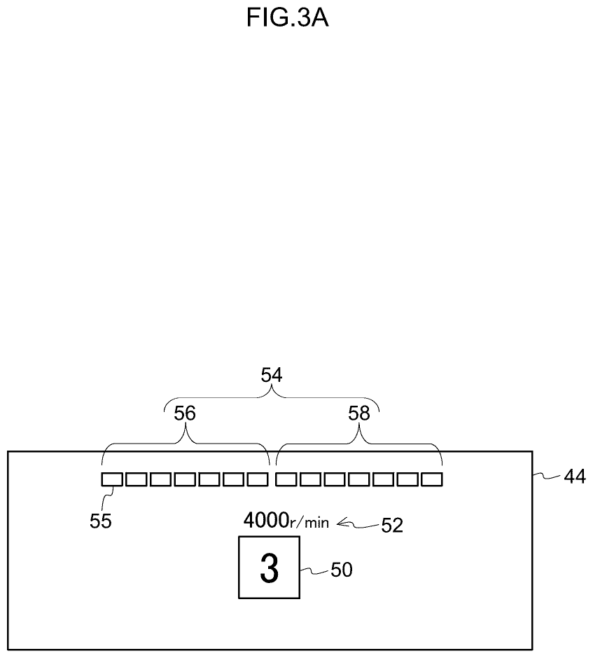

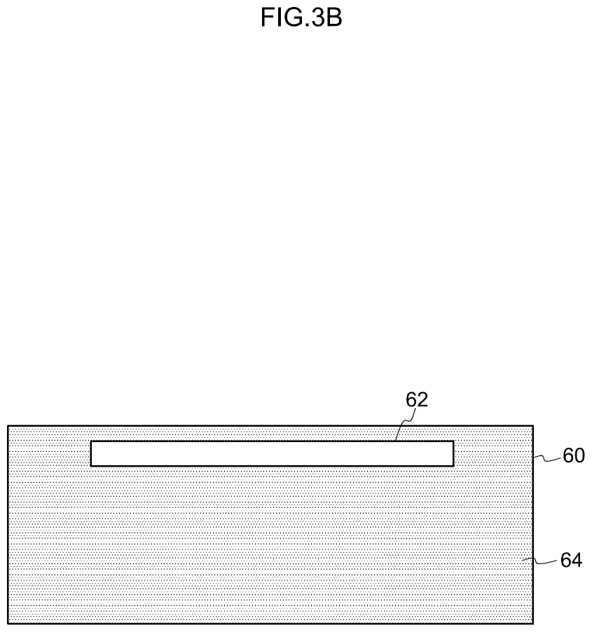

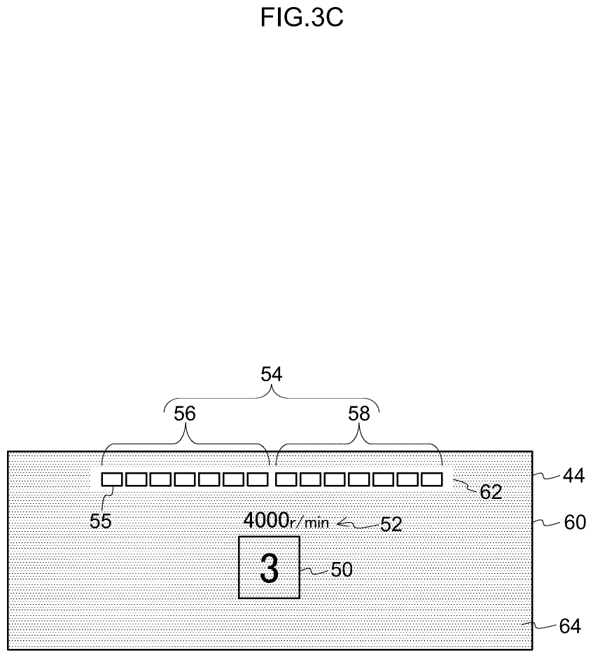

In step S11, the CPU 21 displays on the monitor 44 a shift-up indicator 54 (see FIG. 3 etc.) that notifies the driver of the vehicle 10 of the timing for shifting gear upward as vehicle information regarding the vehicle 10. Then, the CPU 21 proceeds to step S12. The shift-up indicator 54 is an example of “specified information”. Here, in the vehicle 10, the travel performance of the vehicle 10 is changed by another ECU 30 based on the CPU 21 displaying the shift-up indicator 54 on the monitor 44. Thus, in the vehicle 10, for example, turbo lag is reduced, the upper limit vehicle speed at which the speed limiter of the vehicle 10 is actuated is raised, or the output of the cooling fan is maximized.

In step S12, the CPU 21 increases the brightness of the monitor 44. As an example, the CPU 21 increases the luminance value of the entire monitor 44 by a predetermined amount. Then, the CPU 21 proceeds to step S13.

In step S13, among the vehicle information displayed on the monitor 44, the CPU 21 causes a specifying layer 60 (see FIG. 3B), in which the opacity of a specifying portion 62 (see FIG. 3B) in which the shift-up indicator 54 is displayed, is lower than the opacity of the remaining portion 64 (see FIG. 3B) in which other vehicle information is displayed, to be superimposed on the monitor 44. Then, the CPU 21 ends the specifying processing.

Explanation follows regarding an example in which the specifying layer 60 is superimposed on the monitor 44, with reference to FIGS. 3A to 3C.

FIG. 3A shows vehicle information displayed on the monitor 44. In FIG. 3A, gear stage information 50, rotational speed information 52, and a shift-up indicator 54 are displayed as vehicle information.

The gear stage information 50 indicates a gear stage of the vehicle 10. In FIG. 3A, “3” is displayed as the gear stage information 50, indicating that the gear stage is third gear.

The rotation speed information 52 indicates the engine rotation speed of the vehicle 10. In FIG. 3A, “4000 r/min” is displayed as the rotation speed information 52, indicating that the engine rotation speed is 4000 revolutions per minute.

The shift-up indicator 54 includes plural gauges 55 that are aligned along the left-right direction in the monitor 44 and that are illuminated in conjunction with an increase in the engine speed of the vehicle 10. In FIG. 3A, a total of 14 rectangular gauges 55 are illustrated at the left and right sides of a center portion of the monitor 44 in the left-right direction, with 7 gauges at the left side and 7 gauges at the right side. In the following, the seven left gauges 55 included in the shift-up indicator 54 are sometimes collectively referred to as a left gauge group 56, and the seven right gauges 55 are sometimes collectively referred to as a right gauge group 58. The left and right direction is an example of a “predetermined direction”. Note that the plural gauges 55 are not limited to being aligned along the left-right direction in the monitor 44, and may be aligned along the up-down direction. In such cases, the up-down direction is an example of the “predetermined direction”.

In FIG. 3A, all the gauges 55 are represented in white, indicating that none of the gauges 55 is illuminated.

FIG. 3B shows a specifying layer 60. The specifying layer 60 has the same size and shape as the monitor 44 illustrated in FIG. 3A. The specifying layer 60 is a layer for lowering the transmittance of light emitted by the monitor 44. The specifying layer 60 is generated by combining, for example, the three elements of hue, lightness, and saturation.

As illustrated in FIG. 3B, the specifying layer 60 is configured including a specifying portion 62 that is rectangular in shape, and a remaining portion 64 other than the specifying portion 62. The specifying portion 62 is a portion that covers the display area of the shift-up indicator 54 on the monitor 44 in a state in which the specifying layer 60 is superimposed on the monitor 44. The specifying portion 62 is formed in a size and shape that enables it to cover the display area of the shift-up indicator 54.

Note that the opacity of the specifying portion 62 is lower than the opacity of the remaining portion 64. After the specifying layer 60 in the present exemplary embodiment has set an overall opacity that lowers the transmittance of light emitted by the monitor 44 by a predetermined amount, the specifying portion 62 is generated by opening a gap in a portion that covers the display region of the shift-up indicator 54 when superimposed on the monitor 44. Thus, the opacity of the specifying portion 62 becomes “0”, and when the specifying layer 60 is superimposed on the monitor 44, the transmittance of light emitted from the display region of the shift-up indicator 54 is not reduced.

FIG. 3C illustrates a display example of a case in which the specifying layer 60 illustrated in FIG. 3B is superimposed on the monitor 44 illustrated in FIG. 3A. As illustrated in FIG. 3C, the specifying layer 60 and the monitor 44 are overlaid such that respective end portions—specifically, the four corners—match. Thus, in the monitor 44 illustrated in FIG. 3C, the specifying portion 62 covers the display region of the shift-up indicator 54, such that the light transmittance of the monitor 44 emitted from this display region is not reduced. Further, in the monitor 44, the remaining portion 64 overlaps areas other than the display region, such that the transmittance of light from the monitor 44 emitted from these areas is reduced. Note that in FIG. 3C, by representing portions in the vicinity of the shift-up indicator 54 in white, and representing other portions in color, this indicates that only the transmittance of light emitted from the display region of the shift-up indicator 54 in the monitor 44 is not reduced.

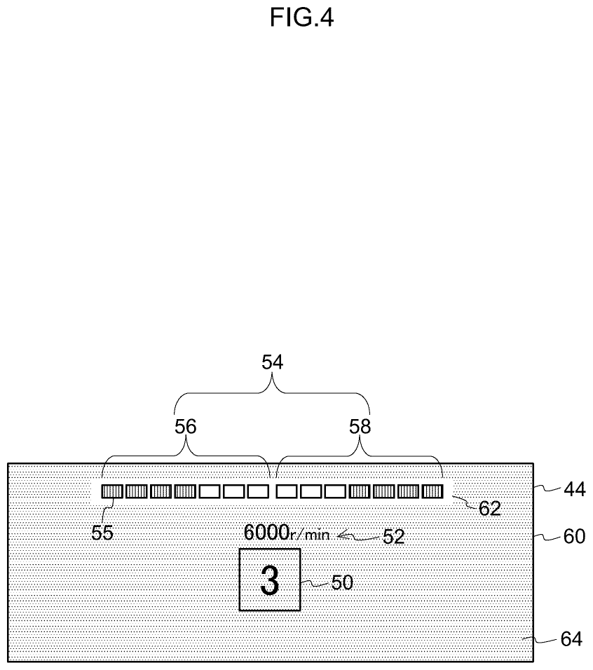

Explanation follows regarding changes in the illumination color of the gauges 55, with reference to FIGS. 4 to 6.

FIG. 4 is a first explanatory view illustrating changes in illumination color of the gauges 55. Similarly to in FIG. 3, gear stage information 50, rotational speed information 52, and a shift-up indicator 54 are displayed as vehicle information on the monitor 44 illustrated in FIGS. 4 to 6.

Note that in FIG. 4, “6000 r/min” is displayed as the rotation speed information 52, indicating that the engine rotation speed is 6000 revolutions per minute. In FIG. 4, with an increase in the engine speed, four gauges 55 from the left in the fourth gauge group 56 and four from the right in the fourth gauge group 58 are illuminated. At such time, as a function of the control unit 21B, the CPU 21 gradually illuminates the gauges 55 from both left and right end portions of the monitor 44 toward the center. In the case of FIG. 4, the CPU 21 first illuminates the first gauge 55 from the left of the left gauge group 56 and the first gauge 55 from the right of the right gauge group 58. Next, the CPU 21 further illuminates the second gauge 55 from the left of the left gauge group 56 and the second gauge 55 from the right of the right gauge group 58. Next, the CPU 21 further illuminates the third gauge 55 from the left of the left gauge group 56 and the third gauge 55 from the right of the right gauge group 58. Finally, the CPU 21 illuminates the fourth gauge 55 from the left of the left gauge group 56 and the fourth gauge 55 from the right of the right gauge group 58, and establishes the illumination state illustrated in FIG. 4.

Further, in FIG. 4, the four gauges 55 from the left in the left gauge group 56 and the four gauges 55 from the right in the right gauge group 58 are represented by vertical line hatching, which indicates that these gauges 55 are illuminated with a green illumination color.

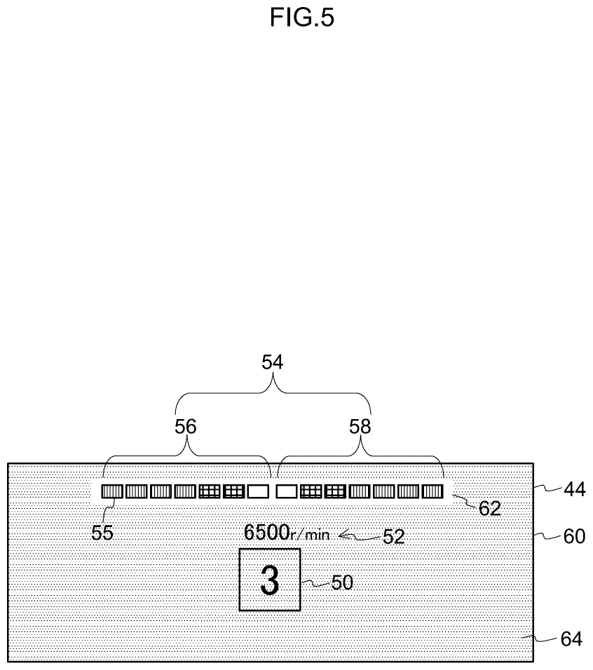

FIG. 5 is a second explanatory view illustrating changes in the illumination colors of the gauges 55.

Note that in FIG. 5, “6500 r/min” is displayed as the rotation speed information 52, indicating that the engine rotation speed is 6500 revolutions per minute. In FIG. 5, in conjunction with the increase in engine speed, the fifth and sixth gauges 55 from the left of the left gauge group 56 and the fifth and sixth gauges 55 from the right of the right gauge group 58 are illuminated in a different illumination color from that of the four gauges 55 from the left in the left gauge group 56 and the four gauges 55 from the right in the fourth gauge group 58.

In the case of FIG. 5, first, the CPU 21 illuminates the fifth gauge 55 from the left of the left gauge group 56 and the fifth gauge 55 from the right of the right gauge group 58 from the illumination state illustrated in FIG. 4. Then, the CPU 21 further turns on the sixth gauge 55 from the left of the left gauge group 56 and the sixth gauge 55 from the right of the right gauge group 58, and establishes the illumination state illustrated in FIG. 5. At such time, as a function of the control unit 21B, the CPU 21 changes the illumination color of the gauge 55 in accordance with the engine speed. Specifically, the CPU 21 illuminates the fifth and sixth gauges 55 from the left of the left gauge group 56 and the fifth and sixth gauges 55 from the right of the right gauge group 58 with an orange illumination color. Note that in FIG. 5, the fifth and sixth gauges 55 from the left of the left gauge group 56 and the fifth and sixth gauges 55 from the right of the right gauge group 58 are represented by grid-like hatching. This indicates that these gauges 55 are illuminated in a different illumination color from the other gauges 55 represented by vertical line hatching.

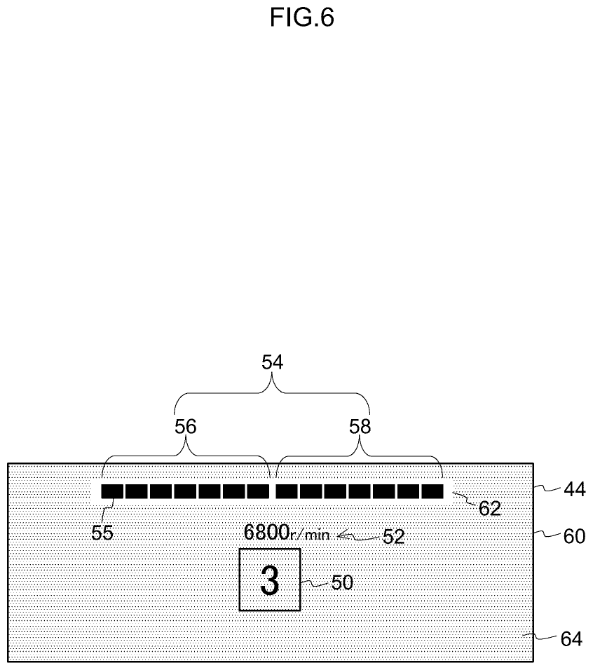

FIG. 6 is a third explanatory view illustrating changes in illumination color of the gauges 55.

Note that in FIG. 6, “6800 r/min” is displayed as the rotation speed information 52, indicating that the engine rotation speed is 6800 revolutions per minute. In FIG. 6, all of the gauges 55 in the left gauge group 56 and the right gauge group 58 are illuminated in conjunction with an increase in the engine speed.

In the case of FIG. 6, the CPU 21 illuminates all the gauges 55 in the left gauge group 56 and the right gauge group 58 from the illumination state illustrated in FIG. 5, and establishes the illumination state illustrated in FIG. 6. At such time, the CPU 21 illuminates all the gauges 55 as a function of the control unit 21B, and the illumination color of all the gauges 55 is changed to a specific color when all the gauges 55 are illuminated. Specifically, the CPU 21 changes the illumination colors of all the gauges 55 to a blue illumination color that was not used in the previous illumination states. Thus, in the monitor 44 illustrated in FIG. 6, by illuminating all the gauges 55 provided in the shift-up indicator 54, notification is provided that the timing for shifting up from third gear to fourth gear has arrived. Note that in FIG. 6, all the gauges 55 in the left gauge group 56 and the right gauge group 58 are represented in black, which indicates that these gauges 55 are illuminated with a blue illumination color.

As explained above, in the meter ECU 20, the CPU 21 increases the brightness of the monitor 44, and further, a specifying layer 60, in which the opacity of the specifying portion 62 at which the shift-up indicator 54 is displayed is lower than the opacity of the remaining portion 64 at which other vehicle information is displayed, is displayed overlaid on the monitor 44. Thus, according to the meter ECU 20, by making the brightness of the shift-up indicator 54 displayed on the monitor 44 relatively higher than the brightness of other vehicle information, among the vehicle information displayed on the monitor 44, the shift-up indicator 54 can be displayed in an emphasized manner compared to other vehicle information.

Further, in the meter ECU 20, the CPU 21 displays the shift-up indicator 54 on the monitor 44 based on the permission conditions for changing the travel performance of the vehicle 10 having been satisfied. Thus, according to the meter ECU 20, in an environment in which the travel performance of the vehicle 10 can be changed, among the vehicle information displayed on the monitor 44, the shift-up indicator 54 can be displayed in an emphasized manner compared to other vehicle information.

In the meter ECU 20, the CPU 21 displays the shift-up indicator 54 at the top of the vehicle information displayed on the monitor 44. Thus, according to the meter ECU 20, by displaying the shift-up indicator 54 at the top of the vehicle information displayed on the monitor 44, it is possible for the driver to be cognizant of the timing of the shift-up without excessively dropping his/her line of sight while the vehicle 10 is traveling.

The shift-up indicator 54 is provided with plural gauges 55 that are illuminated in conjunction with an increase in engine speed. Further, in the meter ECU 20, in conjunction with an increase in engine speed, the gauges 55 are gradually illuminated from both left and right end portions of the monitor 44 toward the center, and further, the illumination color of the gauges 55 is changed in accordance with the engine speed. Thus, according to the meter ECU 20, by changing the illumination color of the gauges 55 in accordance with the engine speed, it is possible for the driver to be made aware that the timing for shifting gear upward is approaching.

In the meter ECU 20, in a case in which all of the plural gauges 55 are illuminated, the CPU 21 changes the illumination color of all of the gauges 55 to a specific color for illuminating all of the gauges 55. Thus, the meter ECU 20 enables the driver to be made aware that the timing for shifting up has arrived, as a result of illuminating all the gauges 55 with a specific color.

### Other Matters

In the above exemplary embodiment, the CPU 21 determines that the permission condition has been satisfied when the current position of the vehicle 10 measured by the GPS sensor included in the sensor group 42 belongs to a predetermined travel area. However, the timing at which it is determined by the CPU 21 that the permission condition has been satisfied is not limited thereto. For example, the CPU 21 may determine that the permission condition has been satisfied when a predetermined input operation for changing the travel performance of the vehicle 10 has been performed with respect to the vehicle 10.

In the above exemplary embodiment, in the specifying layer 60, the specifying portion 62 is generated by opening a gap in a portion that covers the display region of the shift-up indicator 54 when superimposed on the monitor 44. However, the specifying portion 62 is not limited to being generated by opening a gap in the specifying layer 60. For example, in the specifying layer 60, the specifying portion 62 may be generated by applying a gradation of color, lightness and darkness, or the like, that is different from other portions to a portion that covers the display region of the shift-up indicator 54 when superimposed on the monitor 44.

In the above exemplary embodiment, plural levels of brightness values to be set for the entire monitor 44 are provided, and the CPU 21 may change the degree to which the brightness of the monitor 44 is increased in accordance with a selection by the driver.

In the above exemplary embodiment, the CPU 21 may change at least one of the brightness of the monitor 44 or the opacity of the specifying layer 60 based on environment information indicating the environment outside the vehicle 10. For example, in cases in which the amount of light received by an illuminance sensor included in the sensor group 42 is less than a predetermined amount, the CPU 21 may increase the brightness of the monitor 44 and reduce the opacity of the specifying layer 60.

The illumination colors of the gauges 55 explained in the above exemplary embodiment are merely examples, and there is no particular limitation on the illumination color.

In the above exemplary embodiment, the shift-up indicator 54 is an example of specified information; however, the specified information is not limited thereto. For example, the specified information may be, in addition to the shift-up indicator 54, among the vehicle information relating to the vehicle displayed on the monitor 44, the gear stage information 50, information relating to a telltale that gives a warning to the driver, information relating to predetermined instruments, and the like. The specified information is not limited to a single item of vehicle information, and may be plural items of vehicle information such as the gear stage information 50 and the shift-up indicator 54, for example. When the specified information is plural items of vehicle information, the specifying portion 62 is provided in accordance with the number of items of specified information in the specifying layer 60. Namely, two or more portions of the specifying layer 60 that are lower than the opacity of the remaining portion 64 may be provided.

In the above exemplary embodiment, the region serving as the specifying portion 62 in the specifying layer 60 may dynamically change in conjunction with an increase in the engine speed of the vehicle 10. For example, the CPU 21 may enlarge the area to become the specifying portion 62 in the specifying layer 60 in accordance with the number of illuminated gauges 55 in the shift-up indicator 54. In such cases, in the example illustrated in FIG. 4, the CPU 21 designates portions that cover the four gauges 55 from the left in the left gauge group 56 and the four gauges 55 from the right in the right gauge group 58 as the specifying portion 62. Thereafter, in a case in which the fifth and sixth gauges 55 from the left in the left gauge group 56 and the fifth and sixth gauges 55 from the right in the right gauge group 58 are illuminated owing to an increase in the engine speed, as in the example illustrated in FIG. 5, the CPU 21 may enlarge the specifying portion 62 to portions that cover the sixth gauge 55 from the left in the left gauge group 56 and the sixth gauge 55 from the right in the right gauge group 58.

Note that various processors other than the CPU may execute the specifying processing that is executed by the CPU 21 loading and executing software (programs) in the above exemplary embodiment. Examples of the hardware processor in such cases include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The specific processing may be executed by one of these various processors, or may be executed by a combination of two or more processors of the same type or different types (such as plural FPGAs, or a combination of a CPU and an FPGA). More specifically, the hardware configuration of these various processors is an electrical circuit including circuit elements such as semiconductor elements and the like in combination.

In the above exemplary embodiment, an aspect in which the information processing program 24A is stored (installed) in advance in the storage 24 has been described; however, the present disclosure is not limited thereto. The information processing program 24A may be provided in a form recorded in a non-transitory computer-readable recording medium, such as a CD-ROM (Compact Disk Read Only Memory), a DVD-ROM (Digital Versatile Disk Read Only Memory), or a USB (Universal Serial Bus) memory. Further, the information processing program 24 A may be downloaded from an external device through a network.

There are cases in which it is desirable to improve the visibility of some of the information displayed at a display unit inside a vehicle as disclosed in JP-A No. 2013-57568. For example, in such cases, simply by increasing the brightness of the entire display unit, information other than the portion of information for which enhanced visibility was desired is emphasized, and the display content of the display unit becomes a nuisance to the driver.

Therefore, an object of the present disclosure is to provide an information processing device that, among vehicle information relating to the vehicle displayed at a monitor, can display specified information in a more emphasized manner compared to vehicle information other than the specified information.

A first aspect of the present disclosure is an information processing device, including a processor. The processor is configured to increase a brightness of an intra-vehicle monitor provided in front of a driver seat, and display, overlaid on the monitor, a specifying layer in which, among vehicle information related to a vehicle displayed at the monitor, an opacity of a first region, which is a specifying region at which is displayed first information that is specified information, is made lower than an opacity of a second region at which is displayed second information that is the vehicle information other than the specified information.

In the information processing device according to the first aspect, the processor increases the brightness of the monitor, and displays, overlaid on the monitor, a specifying layer in which an opacity of a first region, which is a specifying region at which is displayed first information that is specified information, is made lower than an opacity of a second region at which is displayed second information that is vehicle information other than the specified information. As a result, according to this information processing device, by making the brightness of the first information displayed at the monitor relatively higher than the brightness of the second information, among the vehicle information displayed at the monitor, the first information can be displayed in an emphasized manner compared to the second information.

A second aspect of the present disclosure is the information processing device of the first aspect, wherein the processor is configured to display the first information at the monitor based on a permission condition for changing a travel performance of the vehicle having been established.

In the information processing device according to the second aspect, the processor displays the first information on the monitor based on a permission condition for changing the travel performance of the vehicle having been satisfied. As a result, according to this information processing device, in an environment in which it is possible to change the vehicle travel performance, among the vehicle information displayed at the monitor, the first information can be displayed in an emphasized manner compared to the second information.

A third aspect of the present disclosure is the information processing device of the first aspect, wherein: the first information is a shift-up indicator that notifies a driver of the vehicle of a timing for shifting gear upward, and the processor is configured to display the shift-up indicator at an uppermost part among the vehicle information displayed at the monitor.

In the information processing device according to the third aspect, the first information is a shift-up indicator that notifies the driver of the timing for shifting up. Further, the processor causes the shift-up indicator to be displayed at an uppermost part among the vehicle information displayed at the monitor. As a result, according to this information processing device, by making the brightness of the shift-up indicator displayed on the monitor relatively higher than the brightness of the second information, among the vehicle information displayed on the monitor, the shift-up indicator can be displayed in an emphasized manner compared to the second information. In addition, according to this information processing device, by displaying the shift-up indicator at the top of the vehicle information displayed at the monitor, it is possible for the driver to be cognizant of the timing of the shift-up without excessively dropping his/her line of sight while the vehicle 10 is traveling.

A fourth aspect of the present disclosure is the information processing device of the third aspect, wherein: the shift-up indicator comprises a plurality of gauges that are aligned along a predetermined direction in the monitor and that are illuminated in conjunction with an increase in engine speed of the vehicle, and the processor is configured to, in conjunction with the increase in engine speed, gradually light the gauges from respective ends towards a center in the predetermined direction, and to change an illumination color of the gauges in accordance with the engine speed.

In the information processing device according to the fourth aspect, the shift-up indicator includes plural gauges that are aligned along a predetermined direction in the monitor and that are illuminated in conjunction with an increase in engine speed. Further, in conjunction with the increase in engine speed, the processor gradually illuminates the gauges from respective ends towards a center in the predetermined direction, and changes the illumination color of the gauges in accordance with the engine speed. As a result, according to this information processing device, by changing the illumination color of the gauges in accordance with the engine speed, it is possible for the driver to be made aware that the timing for shifting up is approaching.

A fifth aspect of the present disclosure is the information processing device of the fourth aspect, wherein the processor is configured to change the illumination color of all of the gauges to a specific color for use when illuminating all of the gauges in a case in which all of the plurality of gauges are illuminated.

In the information processing device according to the fifth aspect, in a case in which all of the plural gauges are illuminated, the processor changes the illumination color of all of the gauges to a specific color for use when illuminating all of the gauges. As a result, according to this information processing device, by illuminating all of the gauges with a specific color, the driver can be made aware that the timing for shifting up has arrived.

### Effect of Invention

As explained above, with the information processing device according to the present disclosure, among vehicle information relating to the vehicle displayed at a monitor, specified information can be displayed in a more emphasized manner compared to vehicle information other than the specified information.

1. An information processing device, comprising a processor, the processor being configured to increase a brightness of an intra-vehicle monitor provided in front of a driver seat, and display, overlaid on the monitor, a specifying layer in which, among vehicle information related to a vehicle displayed at the monitor, an opacity of a first region, which is a specifying region at which is displayed first information that is specified information, is made lower than an opacity of a second region at which is displayed second information that is the vehicle information other than the specified information.

2. The information processing device of claim 1, wherein the processor is configured to display the first information at the monitor based on a permission condition for changing a travel performance of the vehicle having been established.

3. The information processing device of claim 1, wherein:
the first information is a shift-up indicator that notifies a driver of the vehicle of a timing for shifting gear upward, and
the processor is configured to display the shift-up indicator at an uppermost part among the vehicle information displayed at the monitor.

4. The information processing device of claim 3, wherein:
the shift-up indicator comprises a plurality of gauges that are aligned along a predetermined direction in the monitor and that are illuminated in conjunction with an increase in engine speed of the vehicle, and
the processor is configured to, in conjunction with the increase in engine speed, gradually light the gauges from respective ends towards a center in the predetermined direction, and to change an illumination color of the gauges in accordance with the engine speed.

5. The information processing device of claim 4, wherein the processor is configured to change the illumination color of all of the gauges to a specific color for use when illuminating all of the gauges in a case in which all of the plurality of gauges are illuminated.
